(19) United States
(12) Patent Application Publication
(10) Pub. No.: US 2009/0127839 A1
(43) Pub. Date: May 21, 2009

(54) AXLE-MOUNTED TRAILER SKID PLATE

(76) Inventor: Mark D. Long, Mobile, AL (US)

Correspondence Address: Donald W. Meeker;Patent Agent, 924 East Ocean Front #E,, Newport Beach, CA, 92661, US

(21) Appl. No.: 11/985,364

(22) Filed: Nov. 15, 2007

(51) Int. Cl. B60S 9/00

(52) U.S. Cl. 280/757

(57) ABSTRACT

Each of a pair of skid plate assemblies attaches by a mounting plate to the axle and leaf springs of a trailer using inverted U-bolt. The steel skid plate mounts to the mounting plate by a vertical steel tube and two welded angled brace tubes. The front end of the bottom skid plate hooks around and attaches to a crossbar on a bracket hanging down from a forward end of the trailer spring. The back end of the bottom skid plate is formed with a dove tail tip that touches the pavement to create sparks when the trailer tire is disabled to warn other motorists.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to external safety attachments for protecting vehicles and particularly to a pair of axle-mounted skid plates, one skid plate mounted on each side of the trailer on the trailer spring mount and axle just in from of a tire on each side with the bottom of the skid plate below the hub of the tire; each trailer axle skid plate comprises a top mounting plate which attaches the device to the trailer axle and leaf springs using inverted U-bolts, a vertical steel tube which extends down from the top mounting plate and two welded angled brace tubes extending down from the vertical steel tube, all three of which are welded to a curved bottom road-contacting steel skid plate, the steel skid plate acting like a ski to skid along the road keeping the axle as well as the rim of the tire from hitting or touching the pavement when the tire blows or falls off; the front end of the curved bottom skid plate hooking over a crossbar on a bracket hanging down from a forward end of the trailer spring and a back end of the curved bottom skid plate formed in a dove tail with the back tip which touches the pavement to create sparks when the trailer tire is disabled.

2. Description of Related Art Including Information Disclosed Under 37 CFR 1.97 and 1.98

The problem of wheels and tires accidentally coming off trailers poses a danger to the safety of people and property both inside and outside such vehicles. This problem may occur due to a failure in the fastening mechanisms, such as nuts and bolts, between a wheel and the vehicle, or due to a faulty tire. If a tire on a single axle trailer should blow or fall off, the trailer will begin to sway until soon it is in a violent fishtailing motion which endangers not only the driver of the vehicle towing the trailer, but also other vehicles, people, and property nearby. What is needed is a device which will keep a trailer from whipping back and forth behind a vehicle, so the driver of the towing vehicle can drag the disabled trailer off the road safely.

Prior art U.S. Pat. No. 1,426,664, issued Aug. 22, 1922 to Merchant, is for a rocking-type jack for a vehicle which comprises a clip engageable with an axle of the vehicle.

Prior art U.S. Pat. No. 1,805,508, issued May 19, 1931 to Angelillo, provides a vehicle jack comprising a curved base member and an elongated shaft that extends upwardly from the curved base. This shaft includes a plurality of openings that are adapted to receive a curved hook and rigid pin. This curved hook is adapted to receive an axle of a vehicle. Due to the series of openings, the pins may be entered at different heights relative to the base, thereby enabling the jack to accommodate a variety of wheel diameters.

Prior art U.S. Pat. No. 3,588,048, issued Jun. 28, 1971 to McCorrison, shows a primarily circular rocker-type jack for trailers having an a readily releasable axle-engaging collar. The outer perimeter is provided with traction enhancing means and a flattened portion for stabilizing the jack.

Two prior art U.S. patents, U.S. Pat. No. 5,228,651 issued Jul. 20, 1993 and U.S. Pat. No. 5,039,070 issued Aug. 13, 1991 to Warner, claim a jack stand for using the drive power of a vehicle to lift the vehicle off the ground. The jack stand has a retention device such as a cradle to engage an undercarriage member of the vehicle. The retention device is connected to a post which in turn is mounted to a base plate. The base plate is configured to allow the post to pivot to a vertical position as the vehicle is driven over the jack stand so that the post raises the vehicle.

Prior art U.S. Pat. No. 2,001,467, issued May 14, 1935 to Madigan, describes a jack stand having a ground engagement plate and a post mounted to the plate. The post and plate are configured so that the post can engage the axle or other undercarriage member of a vehicle while the post is tilted away from a vertical position. When the vehicle is driven over the jack stand, the post pivots to a vertical position to raise the vehicle.

Prior art U.S. Pat. No. 6,053,477, issued Apr. 25, 2000 to Price, discloses a self-levering vehicle jack which operates by leverage using the motion of the vehicle to lift an axle of the vehicle into the air. The jack has an outer tube which telescopes over an inner tube, and is adjustable for height. A base plate attached to the tubes grips the road surface with a rubber surface or with optional spike projections. An axle contact surface partially surrounds the axle, or is bolted with a U-bolt to the axle.

Prior art U.S. Pat. No. 2,075,934, issued Apr. 6, 1937 to Gold, indicates an emergency appliance for automobiles and like vehicles. The appliance comprises an axle-mounted swingable rocker, which when a tire deflates, is adapted through a spring means to automatically engage the ground thereby sparing the tire further damage.

Prior art U.S. Pat. No. 4,167,270, issued Sep. 11, 1979 to LaPlaca, puts forth a recreational vehicle skid support which includes a pair of skids suspended beneath a vehicle in an operative position in which they are disposed slightly above a road surface, when tires of the vehicle are properly inflated, and adapted for movement in fore and aft directions relative to the direction of vehicle travel. The skids are individually fixed against rearwardly directed movement by a link chain, and resiliently constrained against forwardly directed movements by a coil spring.

Prior art U.S. Pat. No. 2,461,758, issued Feb. 15, 1949 to Moss, concerns tire protecting skid supports, which include a skid fixed to the axle of a vehicle by means of U-bolts to assume an operative position, wherein the skid is aligned with the direction of vehicle travel and disposed for sliding engagement with a road surface upon deflation of an adjacent vehicle tire.

Prior art U.S. Pat. No. 2,134,618, issued Oct. 25, 1938 to Long, illustrates a truck operator controlled, retractable skid having use in both avoiding skidding of a vehicle and aiding return of such vehicle to a road surface in the event the vehicle wheels run off such surface.

Prior art U.S. Pat. No. 1,314,173, issued Aug. 26, 1919 to Waller, is for a skid for use in preventing the overturning of a railroad baggage truck in the event of a truck wheel running into a hole or depression, however, this device is not axle-mounted.

Prior art U.S. Pat. No. 1,907,321, issued May 2, 1933 to Hilstrom, provides a runner attachment for vehicles which is mounted to the vehicle's axle.

Prior art U.S. Pat. No. 1,178,722, issued Apr. 11, 1916 to Hoover, shows a safety attachment for automobile axles. The safety attachment comprises a skid fixed to the axle of a vehicle to assume an operative position, wherein the skid is aligned with the direction of vehicle travel and disposed for sliding engagement with a road surface upon deflation of an adjacent vehicle tire.

Prior art U.S. Pat. No. 1,151,474, issued Aug. 24, 1915 to Kepler, claims an auto attachment for preventing the axle end, or any part of the vehicle, from touching the ground in the event of a wheel falling off. The attachment comprises skids, one for each side of the automobile, which are attached to the vehicle's suspension system.

Prior art U.S. Pat. No. 6,641,160, issued Nov. 4, 2003 to Veal, describes an adjustable skid to be attached to the frame of a boat trailer just forward of the trailer wheels. Two skids would commonly be used, one for each side of the trailer. The function of the skids is to prevent the wheels of the trailer from rolling over the end of the launching ramp.

Prior art U.S. Pat. No. 5,806,871, issued Sep. 15, 1998 to Eggleston, discloses a vehicular trailer having a retractable skid provided for each side of the trailer to extend parallel to the axis of symmetry of the trailer from a position aft of the hitch to a position just forward of the wheels. The skids pivot vertically from a point at the forward end so that the back end of the skids can be lowered and braced to support the trailer and prevent the wheels dropping over the edge of supporting surfaces and becoming jammed against forward movement. Braces extend upward from the skids to the trailer frame when the skids are lowered.

Prior art U.S. Pat. No. 6,869,084, issued Mar. 22, 2005 to Volk, indicates a wheelchair or a vehicle for sand or loose soil which comprises one or more skids, each equipped with a spring-loaded roller or roller plate. It is mentioned that the skid may be used on a trailer, such as a boat trailer or a bicycle trailer.

Prior art U.S. Pat. No. 2,201,373, issued May 21, 1940 to Miniconi, puts forth an automatic jack device for automobiles which comprises an arcuate metal segment which is suspended below the axle by means of an eccentric bracket. When the tire becomes deflated, the vehicle may be backed up slightly and the arcuate metal segment then engages the ground. With the inertia provided by the vehicle, the metal segment lifts the axle so that a repair may be carried out on one of the tires.

What is needed is a pair of skid plates for a trailer which mount securely adjacent to each wheel of the trailer below the level of the wheel hubs to allow the safe towing of the trailer off the road without sway in the event of a wheel failure and which alerts following vehicles about the emergency.

### BRIEF SUMMARY OF THE INVENTION

An object of the present invention is to provide a pair of curved ski-like skid plates securely attachable to the leaf springs of a trailer adjacent to each wheel of the trailer below the level of the wheel hubs to allow the safe towing of the trailer off the road without sway in the event of a wheel failure with dove tails creating sparks to alert adjacent motorists about the emergency.

Another object of the present invention is provide a pair of skid plates which protect the trailer axle as well as the rim of the tire from hitting or touching the pavement in the event of a disabled tire.

In brief, a trailer anti-skid safety device which comprises a pair of skid plates, each of the skid plates is mounted adjacent to an inside of a wheel of a trailer so that a bottom of the skid plate is positioned below the hub of the wheel. Each of the skid plates comprises a top horizontal mounting plate having four holes therethrough to receive the four threaded ends of two U-bolts extending down from an axle and leaf spring on the trailer to attach the mounting plate to a bottom plate on the leaf spring.

Each of the skid plates further comprises a vertical support post permanently attached to a bottom of the top mounting plate and extending downwardly therefrom and a curved bottom road-contacting steel skid plate permanently attached to the bottom of the support post. The steel skid plate comprises a partially convex curved surface on a bottom surface of the road-contacting steel skid to act like a ski to skid along the ground when a trailer tire is disabled, a hook portion on a forward end of the skid plate encircling a crossbar on a forward end of the leaf spring and secured thereto, and a downwardly turned dove tail on a back end of the skid plate having a back tip touching the pavement to create sparks when a trailer tire is disabled. The pair of skid plates allows a trailer to be towed off of a road after a tire is disabled with the adjacent skid plate supporting the trailer and creating warning sparks to notify adjacent motorists of the problem.

The purpose of the device is to allow the safe towing of the trailer off the road without sway in the event of a wheel failure with dove tails creating sparks to alert following vehicles about the emergency. The device further serves to protect the trailer axle as well as the rim of the tire from hitting or touching the pavement in the event of a disabled tire.

An advantage of the present invention is that it eliminates the sway of a: trailer if a tire fails.

Another advantage of the present invention is that it creates a visual warning for nearby motorists.

One more advantage of the present invention is that it protects the trailer axle from damage if a tire fails or a wheel falls off.

An additional advantage of the present invention is that it protects the trailer wheel rims in the event that a tire is flat.

A further advantage of the present invention is that it is simple to install.

Yet another advantage of the present invention is that it is inexpensive to manufacture.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a side elevational view of one of the pair of skid plates of the present invention mounted on a leaf spring of a trailer.

### DETAILED DESCRIPTION OF THE INVENTION

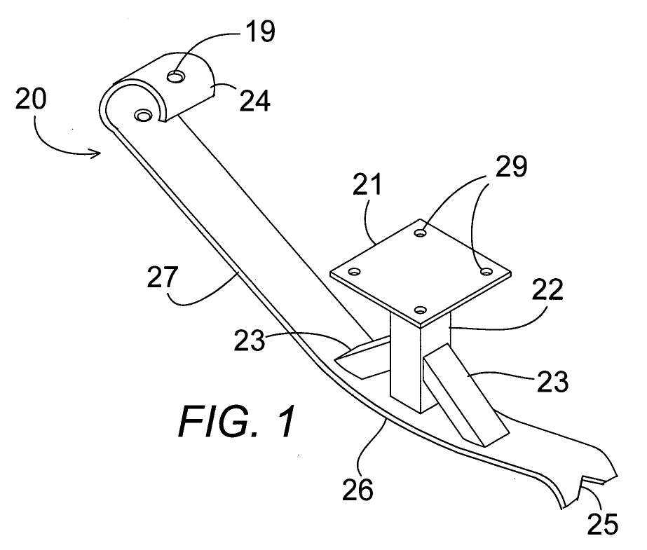

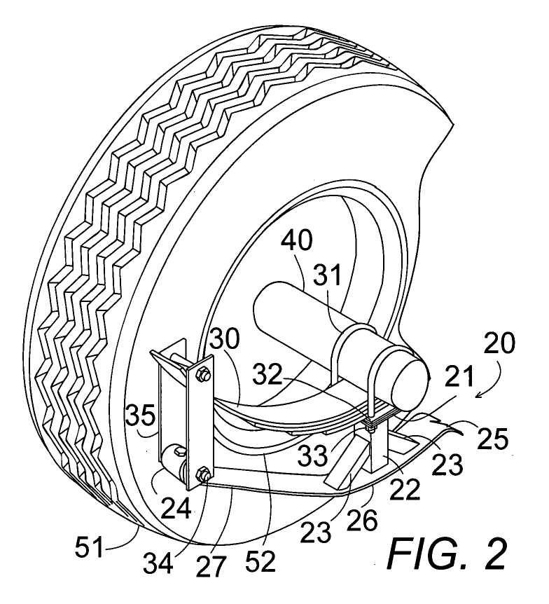

In FIG. 1, a trailer anti-skid safety device comprises a pair of skid plate assemblies 20, each of the skid plate assemblies 20 mounted adjacent to an inside of a wheel 52 of a trailer 50 so that a bottom 27 of the skid plate 20 is positioned below the hub of the wheel 52. Each of the skid plate assemblies 20 comprises a top horizontal mounting plate 21 having four holes therethrough (not shown) to receive the four ends of two U-bolts 31 extending down from the axle 40 and a leaf spring 30 on the trailer 50 to attach the mounting plate 21 to a bottom plate 32 on the leaf spring 30. Each of the skid plate assemblies 20 also comprises a vertical support post 22 permanently attached to a bottom of the horizontal mounting plate 21 and extending downwardly therefrom. The vertical support post 22 preferably comprises a tubular steel post.

Each of the skid plates 20 further comprises a curved bottom road-contacting steel skid plate 27 permanently attached to the bottom of the support post 22. Each skid plate 20 has two angled brace tubes 23 extending down from the vertical steel tube 22 to the bottom skid plate 27 for added support. The steel skid plate 27 comprises a partially convex curved surface 26 on a bottom surface to act like a ski to skid along the ground when a trailer tire 51 is disabled. The steel skid plate 27 also comprises a hook portion 24 on a forward end of the skid plate 27 encircling a crossbar 34 on a forward end of the leaf spring 30 and secured thereto. The hook portion 24 extends under the crossbar 34 and hooks up and over the cross bar 34 to secure the forward end of the skid plate 27 to the forward end of the leaf spring 30. The steel skid plate 27 further comprises a dove tail 25 on a back end of the skid plate 27 having a back tip which touches the pavement to create sparks (not shown) when a trailer tire 51 is disabled or a wheel 52 comes off.

In manufacturing, a steel bottom skid plate 27 is formed with a curled hook 24 at a first end thereof, a convex curved underside 26 in a mid-portion thereof, and a downwardly angled dove tail 25 at a second end thereof. Next, a mounting plate 21 is cut from sheet steel and a mounting hole (not shown) is drilled in each corner thereof. Then, a first end of the steel vertical support post 22 is welded to the center of the bottom of the mounting plate 21. A first end of a first angled brace 23 is welded to a midpoint of a first side of the vertical support post 22. Similarly, a first end of a second angled brace 23 is welded to a midpoint of the opposite side of the vertical post 22. The second ends of the steel vertical post 22 and the angled braces 23 are then all three welded to the top surface of the skid plate 27.

An alternate method of manufacturing may include using other manmade materials in place of steel. With the development of stronger manmade materials and adhesives it may be possible to use plastics, carbon based materials or other manmade materials in place of the steel components 21, 22, 23 and 27 of the axle mounted skid plate 20 which may be adhered together using a super heavy duty adhesive. This alternate method of manufacturing would still require a steel dove tail tip 25 or steel end cap (not shown) to create sparks.

To install a skid plate device 20, front spring brackets 35 which support each end of the horizontal crossbar 34 are mounted, one on the forward end of each trailer leaf LONG spring 30. The hook 24 at the forward end of the skid plate 27 is then hooked up and over the horizontal crossbar 34 to secure the forward end of the skid plate 27 to the forward end of the leaf spring 30. The top of the mounting plate 21 is pressed against the leaf spring bottom plate 32 and U-bolts 31 are then straddled over the trailer axle 40 and the threaded ends of the U-bolts are inserted through apertures (not shown) in the mounting plate 21. The threaded ends of U-bolts are then secured with nuts 33, as shown in FIG. 1. One skid plate 20 is mounted on each side of the trailer 50 on the trailer spring mount 35 and axle 40 just in from the tire 51 on each side with the bottom convex curved surface 26 of the skid plate 27 below the hub 52 of the tire 51. In the event of a flat tire 51, the convex curved underside 26 of the skid plate 27 skids on the road to keep the axle 40 as well as the rim 52 of the tire 51 from hitting or touching the pavement. When the tire 51 is flat or the whole wheel 52 comes off, the dove tail end 25 of the skid plate 27 drags on the pavement creating warning sparks to notify adjacent motorists of the problem. The pair of skid plates 20 allows a trailer 50 to be towed off of a road after a tire 51 is disabled with the adjacent skid plate 20 supporting the trailer 50.

It is understood that the preceding description is given merely by way of illustration and not in limitation of the invention and that various modifications may be made thereto without departing from the spirit of the invention as claimed.

What is claimed is:

1. A trailer anti-skid safety device comprising:
a pair of skid plates, each of the skid plates mounted adjacent to an inside of a wheel of a trailer so that a bottom of the skid plate is positioned below the hub of the wheel, each of the skid plates comprising a top horizontal mounting plate having four holes therethrough to receive the four ends of the two U-bolts extending down from a leaf spring on the trailer to attach the mounting plate to a bottom plate on the leaf spring; a vertical support post permanently attached to a bottom of the horizontal mounting plate and extending downwardly therefrom; a curved bottom road-contacting steel skid plate permanently attached to the bottom of the support post, the steel skid plate comprising at least a partially convex curved surface on a bottom surface to act like a ski to skid along the ground when a trailer tire is disabled, a hook portion on a forward end of the skid plate encircling a crossbar on a forward end of the leaf spring and secured thereto, and a dove tail on a back end of the skid plate having a back tip touching the pavement to create sparks when a trailer tire is disabled to form a pair of skid plates to allow a trailer to be towed off of a road after a tire is disabled with the adjacent skid plate supporting the trailer and creating warning sparks to notify adjacent motorists of the problem.

2. The device of claim 1 wherein the vertical support post comprises a tubular steel post.

3. The device of claim 2 further comprising two angled brace tubes extending down from the vertical steel tube to the skid plate for added support.

4. The device of claim 1 wherein the hook portion extends under the crossbar and hooks up and over the cross bar to secure the forward end of the skid plate to the forward end of the leaf spring.
